(19) United States
(12) Patent Application Publication
(10) Pub. No.: US 2008/0273080 A1
(43) Pub. Date: Nov. 6, 2008

(54) METHOD AND APPARATUS FOR DECISION FEEDBACK LOCATIONING USING DIGTITAL TELELVISION SIGNALS

(75) Inventor: LIN YANG, FREMONT, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 11/744,824

(22) Filed: May 4, 2007

(51) Int. Cl. H04N 5/38

(52) U.S. Cl. 348/21

(57) ABSTRACT

A method using DTV signals for positioning is provided. The method comprises the step of calculating a transmission time of a data segment of a television signal from a transmitter to a mobile receiver.

### FIELD OF THE INVENTION

The present invention relates generally to locationing or determining the exact location of a fixed or moving object, more specifically the present invention relates to feedback the decoded digital television signals for locationing purpose.

### BACKGROUND

Locationing using GPS signals is known. However, GPS has drawbacks such as lack of coverage in in-door and out-door among high-rise buildings.

Digital TV signals are known to be used for receiving digital programs for watching. However, digital signals are known to be used for locationing purposes with significant improvement over GPS. U.S. published patent application No. 20020135518 to Matthew Rabinowitz, et al describes a computer program product, apparatus, and method for use in determining the position of a user terminal that includes receiving at the user terminal a digital television (DTV) broadcast signal transmitted by a DTV transmitter; tracking a periodic component of the DTV signal using a delay lock loop (DLL), including selecting an observation interval based on the timing of the periodic component, and turning on a portion of the DLL during the observation interval, and turning the portion off otherwise; and determining a pseudo-range between the user terminal and the DTV transmitter based on the DTV broadcast signal; and wherein the position of the user terminal is determined based on the pseudo-range and a location of the DTV transmitter. Further, the pseudo-range is determined based on a known digital sequence in the ATSC frame. As can be seen, pilot signal for ATSC is a PN sequence. Pilot is defined as known signal in general.

However, the pilot signals such as a known digital sequence or pseudo noise (PN) sequences typically are spaced a significant time interval apart. Therefore, for a moving object the positioning of same poses various problems such as problems caused by time limitations. As can be appreciated, there is a need to obtain positioning information within a significantly reduced and controllable time segment without the concomitant limitations from using merely the known pilot signal information.

### SUMMARY OF THE INVENTION

A method and device for positioning using Digital TV signals using the unknown data segment of a television signal are provided.

A method is provided for positioning comprising the step of calculating a transmission time of a data segment of a television signal from a transmitter to a mobile receiver, wherein the data segment is unknown to the mobile receiver up to the point in time immediately before transmission.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example digital television signal in accordance with some embodiments of the invention.

FIG. 2 is an example position locationing system in accordance with some embodiments of the invention.

FIG. 3 is an example position locationing device in accordance with some embodiments of the invention.

FIG. 4 is an example of a flowchart in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to positioning using Digital TV signals using the unknown data segment of a television signal. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of positioning using Digital TV signals using the unknown data segment of a television signal described herein. The non-processor circuits may include, but are not limited to, a radio receiver, a radio transmitter, signal drivers, clock circuits, power source circuits, and user input devices. As such, these functions may be interpreted as steps of a method to perform positioning using Digital TV signals using the unknown data segment of a television signal. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

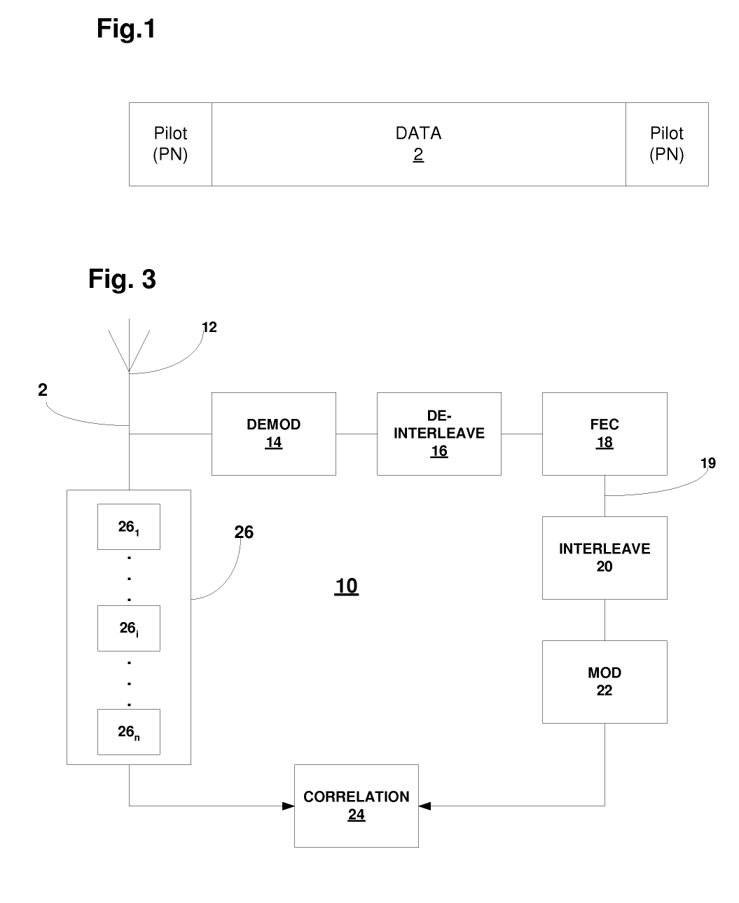

Referring to FIGS. 1-3, depictions of the present invention are shown. In FIG. 1, a transmitted digital television symbol unknown data segment 2 having pilot signals interposed between data segments are shown. The unknown data segments are the information adapted to carry TV programming information. The pilot signals are used to assist the demodulation/decoding of the transmission of the unkown data symbol. Typically, pilot signals comprise known sequence of information for additional purposes.

It is noted that unknown data segments are so referred because a mobile receiver does not know the various parameter including timing or clock info related therewith. For example, data segments or part of a DTV program information may constantly change. Therefore, data segments are unknown as compared to pilot signals that are known. In addition, unknown data segments typically occupy more space or takes more time than a typical pilot signal as the purpose of the DTV information is for a viewer to watch DTV programs which comprises virtually all of the unknown data segments. By way of an example, in a DTV system, the time between two known adjacent pilots is 24 milliseconds (ms). On the other hand, by using embodiment from the present invention, the whole feedback scheme can be done within about 1-2 ms.

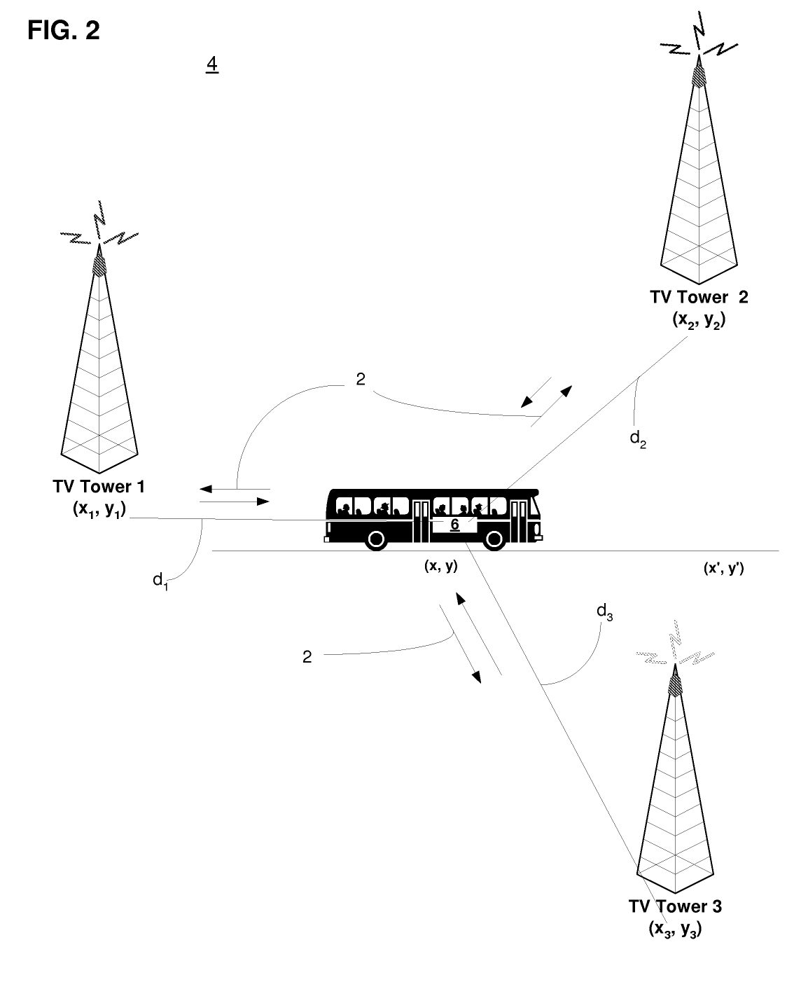

In FIG. 2, a positioning system 4 using digital television (DTV) signals is shown. Three DTV transmitters are provided. They are respectively: transmitter tower 1 having a predetermined position of (x₁, y₁); transmitter tower 2 having a predetermined position of (x₂, y₂); and transmitter tower 3 having a predetermined position of (x₃, y₃). A moving object 6 such as a moving vehicle having users carrying hand held devices is provided. Moving object 6 has a variable position (x, y). The positioning of moving object 6 comprises determine the position (x, y) at time t. Typically, the distance d₁ is defined as the distance between (x₁, y₁) and (x, y). Similarly, d₂ is defined as the distance between (x₂, y₂) and (x, y); as well as d₃ being the distance between (x₃, y₃) and (x, y). As can be seen when moving object 6 moves to a new point (x′, y′), distances between (x₁, y₁) and (x′, y′) changes. Similarly, new d₂ and d₃ need to be derived. Using the three towers each having known position to derive a positioning of moving object 6 is shown in detail in FIG. 3. Once the distance is known, the positioning of moving object 6 can be derived using any type of positioning in a known manner such as triangulation, etc.

As can be seen, only a two dimensional (2D) scheme is shown. However, the present invention contemplates a three dimensional (3D) scheme as well by introducing a third variable z such that d₁-d₃ is define on a 3D co-ordinate with d₁ being the distance between (x₁, y₁, z₁) and (x, y, z). Similarly, d₂ being the distance between (x₂, y₂, z₂) and (x, y, z); and d₃ being the distance between (x₃, y₃, z₃) and (x, y, z).

In FIG. 3, a scheme 10 of using the unknown data segment of a signal is shown. An antenna 12 receives unknown data segment 2 and branches into a first path and a second path. In the first path, unknown data segment 2 is demodulated 14 and deinterleaved 16, or subjected to further forward error correction (FEC) 18 as the case may be. As this juncture, or point 19, unknown data segment 2 is recovered. The recovered data is the DTV signal suitable for further transmission or processing or displaying in a known manner. In other words, before and at point 19, functions or devices of an exiting DTV receiver may be used. No new devices need to be devised or provided before and at point 19. After point 19, the present invention contemplates using the devices of a transmitter and incorporate the same within a receiver or scheme 10 for positioning purposes. Therefore, depending upon the processes performed at the transmitter side (not shown) and processes performed before point 19 at the receiver side as described so far, various novel devices or processes are performed after point 19. The various novel devices or processes comprises an encoder 20 for encoding the DTV signal at point 19, and a interleaver 22 for interleaving the encoded DTV signal after point 19. or any FEC perform by the receiver before point 19. Path 1 terminates at a comparing or correlation block 24 for correlating the restored signal of path 1 with a delayed unknown data segment 2 traversing path 2. This time delay is achieved in block 26 such that the processed unknown data segment 2 of path 1 can be correlated at block 24 on a one-on-one basis.

Block 26 may be subdivided into a set of time delay units. Depending upon a predetermine scheme, various time delays may be selected for use by correlation block 24. It should be noted that multi-path effect are taking into consideration in the present invention, and a value representing the strongest element within a predetermined set of paths is selected for the purpose of computation. The correlated information of block 24 is further used for positioning in a known manner.

Unknown data segment 2 is used in a known manner for the processing of a positioning system. The distances d₁, d₂, and d₃ or the value of (x, y, z) may be measured as follows. By receiving from the 3 TV transmitters TV signals, a time offset between a local clock of that TV transmitter and a reference clock is established. The reference clock may be derived from GPS signals. The use of a reference clock permits the determination of the time offset for each TV transmitter when multiple monitor units (only one shown) are used. Because each monitor unit can determine the time offset with respect to the reference clock, the offsets in the local clocks of the monitor units do not affect these determinations. Alternatively, no external time reference is needed. According to this implementation, a single monitor unit receives TV signals from all three TV transmitters. The single monitor is a built-in device within a user terminal. In effect, the local clock of the single monitor unit functions as the time reference. The single monitor unit and the user terminal are combined as a single unit.

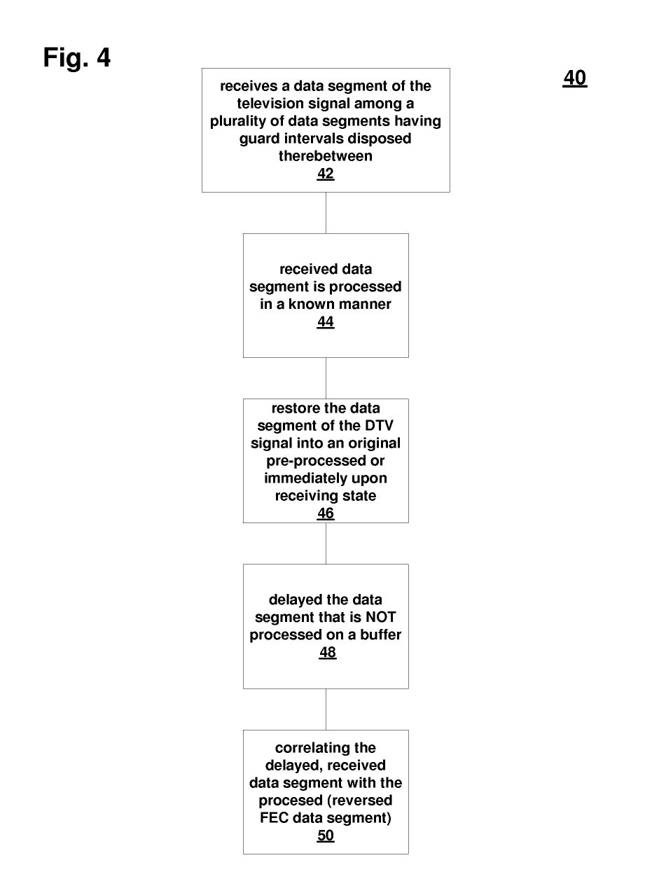

Referring to FIG. 4, a flowchart 40 of the present invention is shown. Flowchart 40 depicts a method for positioning comprising the step of calculating a transmission time of an unknown data segment of a television signal from a transmitter to a mobile receiver. Initially, a receiving side that may be part of a known receiver receives the unknown data segment of the television signal among a plurality of data segments having pilot signals that are known sequences disposed therebetween (Step 42). The received unknown data segment is processed in a known manner such as that which is typical done by a DTV receiver (Step 44). The known manner may include such steps as modulating onto a medium frequency, channel estimation, and any additional forward error correction (FEC), etc. After the DTV signal has been received and restored, a reverse forward error correction (FEC) to restore the unknown data segment 2 of the DTV signal into an original pre-processed or immediately upon receiving state is performed (Step 46). Step 46 may include such steps as encoding and interleaving, etc depending upon the functions of the existing transmission and receiving sides. The reversing step may further comprise the steps of modulating the processed data segment of the television signal. Further, the reversing step may comprise the steps of encoding the processed data segment of the television signal. The corresponding received, unknown data segment is delayed on a buffer (Step 48). The television signal comprises the known pilot signals and the unknown data segments. The buffer buffers_the received, unknown data segment 2 in the second path and compares same with the corresponding, processed unknown data segment 2 of the first path. In other words, a delayed, received data segment is compared with a reversed FEC data segment associated with the received data segment (Step 50). In other words, the unknown data segment 2 that goes through path one is compared with the corresponding delayed, unknown data segment 2 of path two.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A method for positioning comprising the step of calculating a transmission time of a data segment of a television signal from a transmitter to a mobile receiver.

2. The method of claim 1 further comprising the steps of:
receiving the unknown data segment of the television signal;
processing the received unknown data segment of the television signal in a known manner; and
reversing the forward error correction (FEC) to restore the transmitted data segments.

3. The method of claim 1, wherein the reversing step comprises the steps of modulating the processed data segment of the television signal.

4. The method of claim 1, wherein the reversing step comprising the steps of encoding the processed data segment of the television signal.

5. The method of claim 1 further comprising the steps of delaying the received unknown data segment.

6. The method of claim 1, wherein the television signal comprises pilot signal and data segments.

7. The method of claim 1, wherein the calculating step comprises correlating a delayed, received unknown data segment with a reversed FEC data segment associated with the received data segment.

8. An apparatus for positioning comprising a method including the step of calculating a transmission time of a data segment of a television signal from a transmitter to a mobile receiver.

9. The apparatus of claim 8, wherein the method further comprising the steps of:
receiving the unknown data segment of the television signal;
processing the received the unknown data segment of the television signal in a known manner; and
reversing the forward error correction (FEC) process to the restored data segments.

10. The apparatus of claim 8, wherein the reversing step comprises the steps of modulating the processed data segment of the television signal.

11. The apparatus of claim 8, wherein the reversing step comprising the steps of encoding the processed data segment of the television signal.

12. The apparatus of claim 8 wherein the method further comprising the steps of delaying the received unknown data segment.

13. The apparatus of claim 8, wherein the television signal comprises pilot signal and data segments.

14. The apparatus of claim 8, wherein the calculating step comprises correlating a delayed, received unknown data segment with a reversed FEC data segment associated with the received data segment.
